(19) United States
(12) Patent Application Publication
(10) Pub. No.: US 2026/0262669 A1
(43) Pub. Date: Sep. 10, 2026

(54) A HIGH PROTEIN DAIRY PRODUCT

(71) Applicant: Cargill, Incorporated, Wayzata, MN (US)

(72) Inventor: Eliane Yvonne GOOSSENS, NIEL (BE)

(73) Assignee: Cargill, Incorporated, Wayzata, MN (US)

(21) Appl. No.: 19/166,191

(22) PCT Filed: Mar. 20, 2024
(86) PCT No.: PCT/US2024/020641

§ 371 Date: Sep. 17, 2025

(30) Foreign Application Priority Data
Mar. 21, 2023 (EP) 23163125.0

(51) Int. Cl. A23C 9/152

(52) U.S. Cl. CPC A23C 9/1528; A23C 9/1526

(57) ABSTRACT

The present invention relates to method of preparing a plant-based oleosomes enriched protein dairy product comprising the steps of: providing a dairy product having a total amount of dairy protein in the range of 4 to 25% w/w, adding a plant-based oleosome concentrate and obtaining a plant-based oleosomes enriched protein dairy product, wherein the oleosome concentrate is present in an amount of from 0.3 to 12.0 wt. % expressed as dry weight on the total weight of the plant-based oleosomes enriched protein dairy product. The invention moreover relates to such a plant-based oleosomes enriched protein dairy product. In addition, the invention relates to the use of a plant-based oleosome concentrate for improving the mouthfeel of a plant-based oleosomes enriched protein dairy product comprising a dairy product having a total amount of dairy protein in the range of 4 to 25% w/w.

### CROSS-REFERENCE TO RELATED APPLICATIONS

This application claims the benefit of European Patent Application No. 23163125.0, filed 21 Mar. 2023, which is incorporated by reference herein in its entirety.

### FIELD OF THE INVENTION

The present invention relates to a plant-based oleosomes enriched protein dairy product. The present invention further relates to a method for producing such a plant-based oleosomes enriched protein dairy product. The present invention also relates to a use of a plant-based oleosome concentrate in protein dairy products.

### BACKGROUND OF THE INVENTION

High protein acidified dairy products are very popular and are in demand in many markets worldwide. Production of high protein acidified dairy products requires special equipment, which may not be available in standard dairies or may be too expensive to acquire. Further, achieving a high protein acidified dairy product with good organoleptic properties and desired appearance can be challenging.

High protein acidified dairy products are traditionally produced by fermenting a milk with lactic acid bacteria. In order to increase the protein content of the acidified dairy product, water or whey can be drained after fermentation of the milk or alternatively protein can be added to the milk prior to fermentation.

There is still a need in the industry for improving sensorial properties such as taste and/or mouthfeel of these high protein dairy products.

The present invention addresses the above-mentioned problems.

### STATEMENT OF THE INVENTION

The invention relates a method of preparing a plant-based oleosomes enriched protein dairy product comprising the steps of
a) Providing a dairy product having a total amount of dairy protein in the range of 4 to 25% w/w,
b) Adding a plant-based oleosome concentrate and obtaining a plant-based
oleosomes enriched protein dairy product, wherein the oleosome concentrate is present in an amount of from 0.3 to 12.0 wt. % expressed as dry weight on the total weight of the plant-based oleosomes enriched protein dairy product; and
wherein the plant-based oleosome concentrate has a total weight of lipids of between 70 to 98 wt. %, preferably 80 to 97 wt. %, more preferably 85 to 90 wt. %, based on the total dry weight of the plant-based oleosome concentrate; and wherein the protein dairy product is a nutritional composition or a drink.

The invention further relates to the plant-based oleosomes enriched protein dairy product wherein said product is having a total amount of dairy protein in the range of 4 to 25% w/w; and wherein an oleosome concentrate is present in an amount of from 0.3 to 12.0 wt. % expressed as dry weight on the total weight of the plant-based oleosomes enriched protein dairy product; and
wherein the plant-based oleosome concentrate has a total weight of lipids of between 70 to 98 wt. %, preferably 80 to 97 wt. %, more preferably 85 to 90 wt. %, based on the total dry weight of the plant-based oleosome concentrate; and wherein the plant-based oleosomes enriched protein dairy product is a nutritional composition or a drink.

It relates to a plant-based oleosomes enriched protein dairy product prepared by adding a plant-based oleosome concentrate to a dairy product having a total amount of dairy protein in the range of 4 to 25% w/w, and wherein the oleosome concentrate is present in an amount of from 0.3 to 12.0 wt. % expressed as dry weight on the total weight of the plant-based oleosomes enriched protein dairy product.

Finally, the invention relates to a use of a plant-based oleosome concentrate for improving the mouthfeel of a plant-based oleosomes enriched protein dairy product comprising a dairy product having a total amount of dairy protein in the range of 4 to 25% w/w; and wherein the plant-based oleosomes enriched protein dairy product is a nutritional composition or a drink.

### DETAILED DESCRIPTION

The present invention is elucidated below with a detailed description. When used in these specification and claims, the terms “comprises” and “comprising” and variations thereof mean that the specified features, steps or integers are included. The terms are not to be interpreted to exclude the presence of other features, steps or components.

In the present invention, the terms “w/w” and “wt. %” are used interchangeably.

When used in these specification and claims, the terms “dry matter” and “dry substance” are used interchangeably.

The invention relates a method of preparing a plant-based oleosomes enriched protein dairy product comprising the steps of
a) Providing a dairy product having a total amount of dairy protein in the range of 4 to 25% w/w,
b) Adding a plant-based oleosome concentrate and obtaining a plant-based oleosomes enriched protein dairy product,
   wherein the oleosome concentrate is added in an amount of from 0.3 to 12.0 wt. % expressed as dry weight on the total weight of the plant-based oleosomes enriched protein dairy product; and
   wherein the plant-based oleosome concentrate has a total weight of lipids of between 70 to 98 wt. %, preferably 80 to 97 wt. %, more preferably 85 to 90 wt. %, based on the total dry weight of the plant-based oleosome concentrate; and
   wherein the protein dairy product is a nutritional composition or a drink.

With the use of the oleosome concentrate according to the present invention, the present inventors were able to improve mouthfeel, indulgence, and/or protein content of these dairy products without intensifying the off-flavor (“green”, grassy flavour) and even with preventing or reducing or eliminating said off-flavor.

### The Plant-Based Oleosomes Enriched Protein Dairy Product of the Present Invention

The plant-based oleosomes enriched protein dairy product is prepared by adding a plant-based oleosome concentrate to a dairy product having a total amount of dairy protein in the range of 4 to 25% w/w, and wherein the oleosome concentrate is present in an amount of from 0.3 to 12.0 wt. % expressed as dry weight on the total weight of the plant-based oleosomes enriched protein dairy product.

### Dairy Product

The term “dairy product” is encompassing any edible product, preferably any nutritional composition (i.e. a composition comprising nutrients that can be absorbed by the consumer and used for the growth and development of the body), including the high protein dairy products and high protein acidified dairy products, preferably liquid products.

Preferably the dairy product is referring to the high protein dairy products and high protein acidified dairy products, most preferably in liquid form.

Preferably, the dairy product is selected such that the obtained plant-based oleosomes enriched protein dairy product is a nutritional composition which is a composition comprising nutrients that can be absorbed by the consumer and used for the growth and development of the body; and nutritional compositions are compositions that are developed to cover the nutritional needs, of groups of people selected from preterm infants, infants, toddlers, invalids, elderly people, athletes, humans having nutritional deficiencies, humans having problems with swallowing, humans having problems with chewing, and/or humans having a deficient immune system.

It may be designed for people suffering a more specific disease state such as cancer, chronic obstructive pulmonary disease, and later-stage kidney disease and others. Amongst others, nutritional compositions may be helpful for people who struggle with a loss of appetite, have difficulty in chewing, have difficulty in swallowing, have trouble preparing balanced meals, and/or are recovering from surgery or an illness. In the event that the nutritional composition is meant for a complete nutrition, it can provide a healthy balance of protein, carbohydrate, and/or fat.

The present invention relates to a plant-based oleosomes enriched protein dairy product wherein the plant-based oleosomes enriched protein dairy product is a nutritional composition wherein the nutritional composition is a composition developed to cover the nutritional needs of groups of people selected from preterm infants, infants, toddlers, invalids, elderly people, athletes, humans having nutritional deficiencies, humans having problems with swallowing, humans having problems with chewing, and/or humans having a deficient immune system.

The dairy proteins of the dairy product are present in the range of 4 to 25% w/w.

In an aspect of the invention, at least 60% of these dairy proteins are provided by whey protein.

The term “whey protein” relates to the proteins which are present in the serum phase of either milk or coagulated milk, encompassing native whey proteins and whey protein in denatured and/or aggregated form.

In the context of the present invention, the term “whey” relates to the liquid composition which is left when casein has been removed from milk.

There are several methods known to the person skilled in the art to remove casein form milk and in each method the liquid permeate or liquid residue is the whey, whereby the whey can be native, sweetened or acid.

The whey proteins used in the present invention are preferably whey proteins derived from mammalian milk, such as e.g. milk from human, cow, sheep, goat, buffalo, camel, llama, horse and/or deer.

In one aspect of the invention, the whey proteins are bovine whey proteins.

The total amount of dairy protein in the dairy product is in the range of 4-25% (w/w). Preferably the total amount of dairy protein may be in the range of 6-22% (w/w). More preferably, the total amount of dairy protein may be in the range of 8-18% (w/w). More preferably, the total amount of dairy protein may be in the range of 10-16% (w/w). More preferably, the total amount of dairy protein may be in the range of 12-14% (w/w).

In an aspect of the invention, at least 80% (w/w) of the total dairy protein of the dairy product is whey protein. Preferably, at least 85% (w/w) of the total dairy protein of the dairy product is whey protein. More preferably, at least 90% (w/w) of the total dairy protein of the dairy product is whey protein. In some preferred aspects of the invention, up to 100% (w/w) of the total dairy protein of the dairy product is whey protein.

In an aspect of the invention, the total amount of dairy protein of the dairy product comprises at most 20% (w/w) casein. More preferably, the total amount of dairy protein of the dairy product comprises at most 15% (w/w) casein. More preferably, the total amount of dairy protein of the dairy product comprises at most 10% (w/w) casein or even at most 5% (w/w) casein.

Furthermore, it is usually a challenge to have the content of minerals supplied in the dairy product.

In one aspect of the invention, the total amount of Ca2+ and Mg2+ cations of the dairy product may be in the range of 120-800 mg/100 ml.

The dairy product may further comprise other ingredients such as fruits, lipids (other than plant-based oleosome concentrate), carbohydrates, vitamins, sweeteners, carbohydrate based stabilizers and/or emulsifiers.

In an aspect of the invention the lipid other than oleosome concentrate comprises milk lipid and/or vegetable lipid. The milk lipid can be obtained from one or more milk lipid sources, e.g. selected from the group consisting of cream, butter, butter fat, anhydrous milk fat, whey fat, and combinations thereof.

The vegetable lipid optionally present in the dairy product may comprise, one or more fat(s) selected from the group consisting of coconut oil, palm kernel oil, palm kernel olein, shea olein, corn oil, cottonseed oil, flaxseed oil, olive oil, palm oil, groundnut oil, palm olein, rice bran oil, sesame oil, safflower oil, rapeseed oil, soybean oil, sunflower oil, mid-oleic sunflower oil, high-oleic sunflower oil and a combination of two or more thereof.

In one aspect of the invention, the dairy product comprises lipid in an amount in the range of 0.1-20% (w/w), in an amount in the range of 4-18% (w/w) or in an amount in the range of 6-15% (w/w).

The dairy product may furthermore comprise a carbohydrate. The carbohydrate may e.g. comprise di- and/or monosaccharides. The carbohydrate may comprise sucrose, maltose, lactose, dextrose, glucose, fructose, galactose or a combination thereof.

In one aspect of the invention, the dairy product contains a total amount of carbohydrate of from 0.01% (w/w) to 30% (w/w).

In one aspect of the invention, the dairy product is comprising a high intense sweetener commonly known in the art. It may for example be selected from the group consisting of Aspartame, Cyclamate, Sucralose, Acesulfame K, neotame, Saccharin, Neohesperidin dihydrochalcone, Stevia extract, Rebaudioside A, thaumatin, Brazzein, Glycyrrhyzic acid and its salts, Curculin, Monellin, Phylloducin, Rubusosides, Mabinlin, dulcoside A, dulcoside B, siamenoside, and combinations thereof.

In one aspect of the invention, the dairy product is comprising a combination of a carbohydrate and a high intense sweetener, to provide suitable sweetness to the dairy product. In one aspect of the invention, the dairy product may comprise a sweetener that is selected among polyols. Non-limiting examples of useful polyol sweetener are maltitol, mannitol, lactitol, sorbitol, inositol, xylitol, threitol, galactitol, isomaltitol or combinations thereof. If used, the total amount of polyol sweetener is typically in the range of 1-20% (w/w).

In an aspect of the invention, the dairy product may contain carbohydrate-based stabilisers, such as e.g. locust bean gum, guar gum, alginates, cellulose, xanthan gum, carboxymethyl cellulose, micro-crystalline cellulose, carrageenans, pectins, inulin and mixtures of two or more thereof.

In an aspect of the invention, the carbohydrate-based stabilizers are present in an amount of from 0.1% (w/w) to 1% (w/w), and even more preferably no carbohydrate-based stabilizers are present.

In one aspect of the invention, the dairy product may further comprise one of more emulsifier(s). Suitable emulsifiers to be used are mono- and di-glycerides, citric acid esters of mono- and di-glycerides, diacetyltartaric acid esters of mono- and di-glycerides polysorbate, lecithin and/or fractions thereof, or polyol esters of fatty acids such as propylene glycol monoester of fatty acids, as well as natural emulsifiers such as egg yolk, butter milk, raw acacia gum, rice bran extract or mixtures thereof.

The content of the one of more emulsifier(s) may e.g. be in the range of 0.01-3% (w/w) relative to the dry matter of the dairy product.

The dairy product may furthermore comprise one or more vitamin(s) such as vitamin A, vitamin D, vitamin E, vitamin K, thiamine, riboflavin, pyridoxine, vitamin B12, niacin, folic acid, pantothenic acid, biotin, vitamin C, choline, vitamin B8, their salts, their derivatives and combinations thereof. The content of the one of more vitamins may e.g. be in the range of 0.01-1% (w/w) relative to the dry weight of the dairy product, preferably in the range of 0.1 to 0.5% (w/w).

The “plant-based oleosomes enriched protein dairy product” is prepared by adding to such a dairy product a plant-based oleosome concentrate, wherein the oleosome concentrate is present in an amount of from 0.3 to 12.0 wt. % expressed as dry weight on the total weight of the plant-based oleosomes enriched protein dairy product.

The present invention relates to a plant-based oleosomes enriched protein dairy product wherein said product is having a total amount of dairy protein in the range of 4 to 25% w/w; and Wherein an oleosome concentrate is present in an amount of from 0.3 to 12.0 wt. % expressed as dry weight on the total weight of the plant-based oleosomes enriched protein dairy product; and wherein the plant-based oleosome concentrate has a total weight of lipids of between 70 to 98 wt. %, preferably 80 to 97 wt. %, more preferably 85 to 90 wt. %, based on the total dry weight of the plant-based oleosome concentrate; and wherein the plant-based oleosomes enriched protein dairy product is a nutritional composition or a drink.

In an aspect of the invention, the nutritional composition is a composition comprising nutrients that can be absorbed by the consumer and used for the growth and development of the body; and nutritional compositions are compositions that are developed to cover the nutritional needs, of groups of people selected from preterm infants, infants, toddlers, invalids, elderly people, athletes, humans having nutritional deficiencies, humans having problems with swallowing, humans having problems with chewing, and/or humans having a deficient immune system.

It may be designed for people suffering a more specific disease state such as cancer, chronic obstructive pulmonary disease, and later-stage kidney disease and others. Amongst others, nutritional compositions may be helpful for people who struggle with a loss of appetite, have difficulty in chewing, have difficulty in swallowing, have trouble preparing balanced meals, and/or are recovering from surgery or an illness. In the event that the nutritional composition is meant for a complete nutrition, it can provide a healthy balance of protein, carbohydrate, and/or fat.

In an aspect of the invention, the nutritional composition is meant for a complete nutrition, it can provide a healthy balance of protein, carbohydrate, and/or fat.

In an aspect of the invention, the nutritional composition is made available in the form of a liquid, a concentrate, or a cream, preferably a liquid.

In an aspect of the invention, the plant-based oleosomes enriched protein dairy product is a drink comprising dairy proteins in an amount of from 4 to 25% w/w.

### Oleosome Concentrate

Oleosomes, also known as “oil bodies”, “lipid bodies”, “lipid droplets” or “spherosomes”, are pre-emulsified droplets or vesicles of oil stored in plant seeds, nuts or any other plant part and used as energy source for plant growth and metabolism. Oleosomes are typically extracted from cells by a process of grinding the seeds or nuts in the presence of an aqueous solution, such as water, followed by solid-liquid separation to obtain an aqueous dispersion (also called aqueous suspension) of oleosomes. Once isolated/removed from their natural source, these oleosomes are known as “isolated oleosomes”.

With an “oleosome concentrate” as used in the present description is meant an aqueous composition comprising high amounts of dry matter, and more particularly high amounts of isolated plant-based oleosomes.

The vegetable or plant source for obtaining oleosome concentrate may be cells from pollens, spores, seeds or vegetative plant organs in which oleosomes or oleosomes-like organelles are present, preferably a plant seed. The source may be a member of the Brassicaceae, Amaranthaceae, Asparagaceae, Echium, Glycine, Astaraceae, Fabaceae, Malvaceae, Faboidae, Aracaceae, Euphorbiceae, Sinapsis, Lamiaceae, Cyperaceae, Anacardiaceae, Rosaceae, Betulaceae, Juglandaceae, Oleaceae, Lauraceae, Sapotaceae and/or Poaceae families. Preferably, the source is a plant seed from the group of plant species comprising: rapeseed (Brassica spp.), soybean (Glycine max), sunflower (Helianthus annuits)—and their corresponding mid or high oleic varieties-, cottonseed (Gossypium spp.), coconut (Cocus nucifera), linseed/flax (Linum usitatissimum) (including brown (also called bronze) and yellow (also called gold) linseed), hazelnut (Corylus avellana), maize and maize germ (Zea mays), almond (Prunus dulcis), cashew (Anacardium occidentale), olive (Olea), avocado (Persea americana), and shea (Butyrospermum parkii). Other examples that may be used are oil palm (Elaeis guineeis), groundnut (Arachis hypogaea), castor (Ricinus communis), safflower (Carthamus tinctorius), mustard (Brassica spp. and Sinapis alba), coriander (Coriandrum sativum), squash (Cucurbita maxima), Brazil nut (Bertholletia excelsa), walnut (Juglands major), jojoba (Simmondsia chinensis), thale cress (Arabidopsis thaliana), wheat and wheat germ (Triticum spp.), amaranth (family of Amaranthus), sesame (Sesamum indicum), oat (Avena sativa), camelina (Camelina sativa), lupin (Lupinus), peanut (Arachis hypogaea), quinoa (Chenopodium quinoa), chia (Salvia hispanica), yucca, cocoa bean (Theobroma cacao), argan (Argania spinosa), and rice. For all of these any variety with increased level of unsaturated fatty acids compared to the original seed variety may be used. Varieties may be obtained by natural selection or by genetic modification (GMO).

Preferably, the isolated oleosomes present in the oleosome concentrate are sourced from a source selected from the group consisting of rapeseed, soybean, cottonseed, coconut, brown linseed, yellow linseed, hazelnut, maize, sesame, almond, cashew, olive, avocado, shea, and sunflower, and their corresponding mid- or high-oleic varieties, and any variety with increased level of unsaturated fatty acids compared to the original variety. More preferably, from the group consisting of rapeseed and rapeseed varieties with increased level of unsaturated fatty acids compared to the original rapeseed, sunflower, mid- and high-oleic sunflower, soy bean, coconut, brown linseed, yellow linseed and hazelnut. Most preferably, from the group consisting of rapeseed, sunflower, mid- and high-oleic sunflower, soybean, brown linseed and yellow linseed.

In one aspect of the invention, the oleosome concentrate is sourced from sunflower, preferably high-oleic sunflower.

The plant-based oleosome concentrate is present in an amount of from 0.3 to 12.0 wt. % expressed as dry weight of the plant-based oleosome concentrate on the total weight of the plant-based oleosomes enriched protein dairy product. Preferably, the plant-based oleosome concentrate is present in an amount of from 2.0 to 12.0 wt. %, more preferably from 3.0 to 10.0 wt. % expressed as dry weight of the plant-based oleosome concentrate on the total weight of the plant-based food product.

In an aspect of the invention, the plant-based oleosome concentrate has a total dry weight of between 15 to 60 wt. %, preferably 20 to 50 wt. %, more preferably 25 to 45 wt. %, based on the total weight of the plant-based oleosome concentrate.

Furthermore, the plant-based oleosome concentrate may have a high content of isolated plant-based oleosomes so that an optimal effect according to the invention is obtained.

The plant-based oleosome concentrate is having a total weight of lipids of between 70 to 98 wt. %, preferably 80 to 97 wt. %, more preferably 85 to 85 wt. %, based on the total dry weight of the plant-based oleosome concentrate.

In an aspect of the invention, at least 80 wt. %, preferably at least 90 wt. % or at least 95 wt. % or at least 98 wt. %, of the total weight of lipids in the plant-based oleosome concentrate is present in the isolated oleosomes.

Per definition, “total lipids” relates to the sum of triglycerides (TAGs), diacylglycerides (DAGs), monoacylglycerides (MAGs), free fatty acids (FFAs) and phospholipids. “Total lipid weight” as used in the present description means the dry weight of all the lipids present in the concentrate, thus both present in the oleosomes (in the center as well as in the membrane surrounding the oleosome) and outside of the oleosomes, the latter being called “free lipids”. The amount of free lipids is limited. Preferably, substantially all the lipids are present in the oleosomes. The amount of free lipids in the oleosome concentrate can be quantified by extracting the free lipids from the oleosome concentrate with heptane. The heptane will only extract the free lipids, not the lipids present in the oleosomes. Subsequently the amount of lipids in the heptane phase is quantified. Quantification can be done by means of GPC analysis. The amount of lipids in the oleosome concentrate that is present in the oleosomes is calculated as the difference between the total amount of lipids (for example measured by Soxhlet method) and the amount of free lipids in the oleosome concentrate.

Furthermore, the plant-based oleosome concentrate may have a total weight of plant-based proteins of between 2 to 30 wt. %, preferably 3 to 20 wt. %, more preferably 4 to 15 wt. %, based on the total dry weight of the plant-based oleosome concentrate.

The plant-based oleosome concentrate may have a pH value in the range of pH 3 to 10, preferably from pH 4 to 9, more preferably from pH 5 to 8 or between 7.2 and 8.

The plant-based oleosome concentrate comprises isolated oleosomes that may have an average globule diameter in a range of from 0.3 to 15 microns, preferably from 0.6 to 8.0 microns, more preferably from 1.0 to 5.5 microns.

The average globule diameter of the isolated oleosomes in the oleosome concentrate is expressed as the D50-value. The D50-value of oleosomes is the diameter below which 50% of the volume of oleosome particles lies, and it is expressed in micron (=micrometer, symbol: μm). To measure the average globule diameter (D50-value) of the oleosomes, the oleosomes are considered spherical and in the case of non-spherical oleosomes, the diameter is considered as being the largest dimension that can be measured between two opposite points on the surface thereof. To be able to measure the globule diameter of the oleosomes, a Mastersizer 3000 from Malvern equipped with a Hydro module was used during the measurements. A refractive index of 1.47 is used to measure the oleosomes size. The concentration of the oleosomes in the buffer is such that an obscuration in the range from 8.0 to 8.5% in the Mastersizer equipment will be obtained. Obscuration within the Mastersizer is the amount of light blocked or scattered, by the particles. Therefore, the oleosomes are diluted in a buffer solution containing 10 mM sodium phosphate, pH 7.4, and 1.0 wt. % sodium dodecyl sulfate (SDS). For example, about 0.2 wt. % of oleosomes is diluted in the buffer solution and the dilution is further adjusted to obtain the obscuration. Once this optimal obscuration is obtained, the globule diameter is measured, and the average globule diameter (D50-value) can be calculated.

### Method for Producing a Plant-Based Oleosomes Enriched Protein Dairy Product

The present invention relates to a method of preparing a plant-based oleosomes enriched protein dairy product comprising the steps of
i) Providing a dairy product having a total amount of dairy protein in the range of 4 to 25% w/w.
ii) Adding a plant-based oleosome concentrate and obtaining a plant-based oleosomes enriched protein dairy product, and
wherein the oleosome concentrate is present in an amount of from 0.3 to 12.0 wt. % expressed as dry weight on the total weight of the plant-based oleosomes enriched protein dairy product; and
wherein the plant-based oleosome concentrate has a total weight of lipids of between 70 to 98 wt. %, preferably 80 to 97 wt. %, more preferably 85 to 90 wt. %, based on the total dry weight of the plant-based oleosome concentrate; and
wherein plant-based oleosomes enriched protein dairy product is a nutritional composition or a drink.

The detailed explanation of the dairy product and the oleosome has been described under the heading “The plant-based oleosomes enriched protein dairy product of the present invention”.

Each of these steps of the method is discussed below. It should be noted that step ii) may be carried out after or simultaneous with step i). However, there may be one or more optional steps prior to step i), in between step i) and ii) and simultaneous with or after step ii).

### Providing a Dairy Product (Step i)

In step i) of the method according to the present invention, a dairy product is provided.

The “dairy product” is described in detail before. It is prepared by processes well-known by the person skilled in the art.

### Adding a Plant-Based Oleosome Concentrate (Step ii)

In step ii) of the present method a plant-based oleosome concentrate is added to dairy product of step i) and a plant-based oleosomes enriched protein dairy product is obtained.

Methods for obtaining an oleosome concentrate that may be used in step ii) of the process of the present invention are well known in the art. Typically, plants or plant parts, such as seeds or nuts, are obtained using agricultural cultivation practices well known to a person skilled in the art. The plants or plant parts are harvested and, if desired, materials such as stones or hulls (de-hulling) may be removed, for example, sieving or rinsing. Subsequently the plants or plant parts are comminuted (also called grinding) in the presence of an aqueous liquid, e.g. water, into a slurry. The process of comminuting sunflower seeds in the presence of an aqueous liquid is also called wet milling. Following comminuting, solid particles such as fibers are removed from the comminuted slurry by means of centrifugation, decantation or passive filtration over a filter, such as a nylon filter or a cheese cloth, with pore size of for example 80 micron. Subsequently, the isolated oleosome extract is concentrated to obtain an oleosome concentrate.

For concentrating, the oleosome extract is typically centrifuged at a speed sufficient to fractionate the oleosome extract into a light lipid fraction, comprising most of the oleosomes, i.e. the oleosome concentrate, and a heavy, aqueous fraction.

Alternatively, the oleosome extract may be concentrated by means of microfiltration. The microfiltration may be carried out using one or more of the following process conditions:
using a membrane having a pore size of less than 2.0 micron, such as less than 0.1 micron, such as less than 0.5 micron, such as from 0.01 to 1.0 micron, from 0.05 to 0.5 micron, from 0.1 to 0.2 micron,
using a membrane filter that is selected from the group consisting of ceramic membranes, cellulose acetate membranes, polyamides membranes, and polysulphon membranes, and is preferably a ceramic membrane filter,
a transmembrane pressure of less than 3 bar, preferably less than 1.5 bar, more preferably less than 1.2 bar, most preferably from 0.7 to 1.15 bar,
a flux in the range of from 10 to 200 kg/h/m² (kilogram per hour per membrane surface area), preferably from 20 to 180 kg/h/m², more preferably from 30 to 50 kg/h/m²; and/or
a temperature in the range of 20 to 60° C., preferably 40 to 60° C., more preferably 45 to 55° C.

In a specific aspect of the invention, the method for obtaining the plant-based oleosome concentrate used in step ii) is comprising the steps of:
a) comminuting the plants or plant parts in the presence of an aqueous liquid and obtaining a slurry,
b) removing solid particles from the comminuted slurry from step a) and obtaining an isolated oleosome extract, and
c) concentrating the isolated oleosome extract by means of microfiltration and obtaining an oleosome concentrate.

Methods for obtaining the oleosome concentrate may further comprise a step of roasting the plant or plant part, and more preferably seeds, to a certain degree prior to comminuting in order to avoid green taste of the oleosome concentrate. Furthermore, methods for obtaining the oleosome concentrate may also comprise a step of soaking the plant or plant part, and more preferably seeds, prior to comminuting.

The oleosome concentrate may be washed to obtain a washed sunflower oleosome concentrate prior to step ii) of the process according to the invention. For washing, the oleosome concentrate is diluted and subsequently concentrated again. The steps of diluting and subsequently concentrating may be applied at least one time, up to 5 times, preferably up to 3 times. A washed oleosome concentrate is obtained.

In one aspect, the plant-based oleosome concentrate used in step ii) may comprise an oleosome concentrate that has been subjected to an enlargement step prior to step ii) of the process according to the invention. The enlarging may be carried out by applying high-shear centrifugation force to the sunflower oleosome composition and/or a process of applying high-shear mixing to the sunflower oleosome composition, such as described in WO2021126408A1 by the present applicant.

In another aspect, the plant-based oleosome concentrate used in step ii) may comprise an oleosome concentrate that has been subjected to a loading step with one or more source of alpha-linolenic acid (ALA and/or long-chain poly-unsaturated fatty acids (LC-PUFA) and/or medium-chain fatty acids (MCFA) and/or triglyceride having saturated C16 fatty acids that are positioned at the sn2 position and/or lipophilic bioactive substances.

The term “lipophilic dietary bioactive substances” as used in the current description encompasses the bioactive substance as such, as well as its form esterified to a fatty acid. Esterification may make dietary bioactive substances more fat-soluble (i.e.; lipophilic) so they may be easily loaded into the isolated oleosomes. In a preferred aspect of the invention, the oleosome concentrate may comprise one or more lipophilic dietary bioactive substance, selected from the group consisting of vitamin D, vitamin E, vitamin A, vitamin K, ascorbyl palmitate, β-sitosterol, campesterol, stigmasterol, sitostanol, campestanol, and their fatty acid-bound esters.

In step ii) of the present invention, the addition of the plant-based oleosome concentrate to the emulsion of step i) may occur in any suitable way resulting in a homogeneous distribution of the oleosome concentrate into the plant-based oil-in-water emulsion. Examples of suitable ways of addition are blending, homogenization, such as high-pressure homogenization or high-shear homogenization, or the like. Preferably the addition in step ii) of the process occurs by means of homogenization.

In an aspect, the method according to the present invention, the plant-based oleosome concentrate does not comprises any added emulsifiers and/or additives (with “added” is meant in addition to the naturally occurring emulsifiers and/or additives in isolated oleosomes).

The method may further comprise one or more steps of adding one or more additional ingredients prior to, simultaneous with or after step ii). Examples of the one or more additional ingredients that may be added are thickeners, stabilizers, colors, flavors, and nutrients (e.g. vitamin A, vitamin D, calcium).

The present invention relates to the method of preparing a plant-based oleosomes enriched protein dairy product comprising the steps of
i) Providing a dairy product having a total amount of dairy protein in the range of 4 to 25% w/w, and the dairy product comprises lipids in an amount in the range of 0.1-20% (w/w), in an amount in the range of 4-18% (w/w) or in an amount in the range of 6-15% (w/w); and Ca2+ and Mg2+ cations in an amount of from 120-800 mg/100 m¹; and
ii) Adding a plant-based oleosome concentrate and obtaining a plant-based oleosomes enriched protein dairy product,
   wherein the oleosome concentrate is present in an amount of from 0.3 to 12.0 wt. % expressed as dry weight on the total weight of the plant-based oleosomes enriched protein dairy product; and the plant-based oleosomes enriched protein dairy product is having a total amount of dairy protein in the range of 4 to 25% w/w; and wherein the plant-based oleosome concentrate has a total weight of lipids of between 70 to 98 wt. %, preferably 80 to 97 wt. %, more preferably 85 to 90 wt. %, based on the total dry weight of the plant-based oleosome concentrate; and wherein the protein dairy product is a nutritional composition or a drink.

The present invention relates to the plant-based oleosomes enriched protein dairy product that is obtainable by the method of the present invention.

The present invention relates to a plant-based oleosomes enriched protein dairy product having a total amount of dairy protein in the range of 4 to 25% w/w; and wherein the oleosome concentrate is present in an amount of from 0.3 to 12.0 wt. % expressed as dry weight on the total weight of the plant-based oleosomes enriched protein dairy product; and wherein the plant-based oleosome concentrate has a total weight of lipids of between 70 to 98 wt. %, preferably 80 to 97 wt. %, more preferably 85 to 90 wt. %, based on the total dry weight of the plant-based oleosome concentrate; and wherein the protein dairy product is a nutritional composition or a drink.

In an aspect of the invention, it relates to the plant-based oleosomes enriched protein dairy product wherein the plant-based oleosome concentrate comprises isolated oleosomes, wherein at least 80 wt. %, preferably at least 90 wt. % or at least 95 wt. % or at least 98 wt. %, of the total weight of lipids in the plant-based oleosome concentrate is present in the isolated oleosomes.

In an aspect of the invention, the present invention relates to the nutritional composition having a total amount of dairy protein in the range of 4 to 25% w/w; and wherein the oleosome concentrate is present in an amount of from 0.3 to 12.0 wt. % expressed as dry weight on the total weight of the nutritional composition; and wherein the plant-based oleosome concentrate has a total weight of lipids of between 70 to 98 wt. %, preferably 80 to 97 wt. %, more preferably 85 to 90 wt. %, based on the total dry weight of the plant-based oleosome concentrate; wherein the nutritional composition is a composition developed to cover the nutritional needs of groups of people selected from preterm infants, infants, toddlers, invalids, elderly people, athletes, humans having nutritional deficiencies, humans having problems with swallowing, humans having problems with chewing, and/or humans having a deficient immune system.

In an aspect of the invention, the present invention relates to a drink having a total amount of dairy protein in the range of 4 to 25% w/w; and wherein the oleosome concentrate is present in an amount of from 0.3 to 12.0 wt. % expressed as dry weight on the total weight of the drink; and wherein the plant-based oleosome concentrate has a total weight of lipids of between 70 to 98 wt. %, preferably 80 to 97 wt. %, more preferably 85 to 90 wt. %, based on the total dry weight of the plant-based oleosome concentrate.

In an aspect of the invention, it relates to the plant-based oleosomes enriched protein dairy product wherein the plant-based oleosome concentrate comprises isolated oleosomes loaded with one or more sources of linoleic acid (ALA), long-chain polyunsaturated fatty acids (LC-PUFA), medium-chain fatty acids (MCFA), sources of triglycerides having saturated C16 fatty acids that are positioned at the sn2 position, lipophilic dietary bioactive substances or a blend of one or more thereof.

### Use of a Plant-Based Oleosome Concentrate

The present invention further relates to the use of a plant-based oleosome concentrate for improving the mouthfeel of a plant-based oleosomes enriched protein dairy product comprising a dairy product having a total amount of dairy protein in the range of 4 to 25% w/w; and wherein the plant-based oleosomes enriched protein dairy product is a nutritional composition or a drink.

In an aspect of the invention, it relates to the use wherein the plant-based oleosome concentrate is present in an amount of from 0.3 to 12.0 wt. % expressed as dry weight on the total weight of the plant-based oleosomes enriched protein dairy product.

Sensorial properties such as mouthfeel can be expressed amongst others by creaminess, thickness of the plant-based food product.

### Effects of the Invention

By the addition of the oleosome concentrate to a dairy product having a total amount of dairy protein in the range of 4 to 25% w/w), the present inventors were able to improve sensorial characteristics and/or protein content of these products without intensifying the off-flavor (“green” taste) and even with preventing or reducing or eliminating said off-flavor. Improved sensorial characteristics may be the overall odor intensity, creaminess (i.e. a soft full mouthfeel), thickness, and/or lingering effect (i.e. a long lingering aroma/mouthfeel after swallowing).

Although certain aspects of the invention have been described, the scope of the appended claims is not intended to be limited solely to these specific aspects. The claims are to be construed literally, purposively, and/or to encompass equivalents. The scope of the present invention is defined by the appended claims. One or more of the objects of the invention are achieved by the appended claims.

### EXAMPLES

The present invention is further elucidated based on the Examples below which are illustrative only and not considered limiting to the present invention.

### 1. Analysis Methods

### Protein Measurement

The protein content of the oleosomes was determined by the amount of Nitrogen in the sample. This amount of Nitrogen was analyzed using a combustion method according to Dumas. Combustion of the sample was performed at 1100° C. The amount of Nitrogen was determined using a conductivity detector (LECO TruMAc). The protein content was calculated by multiplying the amount of Nitrogen analyzed by 6.25.

### Measurement of the Lipid Content

The weight of free lipids can be measured as well as the weight of total lipids. The difference between these values leads to the weight of lipids that is present inside of the oleosomes.

### Measurement of Free Lipid

400 mg of sunflower oleosome sample was mixed with 7 mL heptane in a capped glass test tube and subjected to ultrasonication for 10 min for extraction of the free oil into the heptane phase. After extraction the solution is centrifuged at 4500 rpm (3283×g) for 5 minutes followed by filtration of the top heptane layer through a 0.45 μm PTFE syringe filter (Merck). The extracted free oil was quantified by gel permeation chromatography (GPC) on an Alliance HPLC system from Waters on two GPC columns placed in series (Styragel HR 1, 100 Å, 5 μm, 7.8 mm×300 mm in DMF, 100-5K, 1/pk; Styragel HR 0.5, 50 Å, 5 μm, 7.8 mm×300 mm in THF, 0-1K, 1/pk Waters HR 0.5, Waters) running isocratically with 2-methyl-tetrahydrofuran at a flow of 0.5 mL/min.

### Measurement of Weight of Total Lipids

The weight of total lipids was determined using the Soxhlet extraction method. It is expressed on total dry weight of the isolated oleosomes.

### Calculation of Lipid Present in Oleosomes

The weight of lipid that is present in the oleosomes of the sunflower oleosome extract or concentrate was calculated by subtracting the amount of free lipid from weight of total lipids of the sunflower oleosome extract or concentrate.

### Measurement of Dry Weight

The percentage dry substance (% DS) of the oleosomes was determined gravimetrically using an MA150 infrared balance (Sartorius). About 2 g of material (i.e; the wet weight (WW)) is applied on an aluminum dish with glass fiber pad. The moisture is evaporated at 105° C. until a stable weight is reached (i.e.; the dry weight (DW)). The percentage dry substance is calculated according to the following formula:

$$\% DS = \frac{DW}{WW} \times 100$$

### Sensorial Evaluation of the Protein Dairy Products (Drinks)

A quantitative descriptive analysis (QDA) of the flavor profile of protein dairy drinks were made according to the method as described in “Sensory Evaluation Practices”, Stone, Bleibaum and Thomas, 2020, page 253-281.

The sensorial profile of each protein dairy drink was made by several trained panelists.

Sensorial attributes defining a sensorial improvement of the protein dairy drinks were:
Overall odor intensity, i.e. the odor intensity immediately after removing the lid of the sample recipient;
Creaminess, i.e. a soft full mouthfeel;
Thickness, i.e. the strength needed to let the sample flow over the tongue;
Lingering, i.e. a long lingering aroma/mouthfeel after swallowing.

The responses from the descriptive sensory evaluation were statistically analysed using an ANOVA model.

### 2. Preparation of the Oleosome Concentrate

### 2.1. Procedure for Obtaining High Oleic (HO) Sunflower Oleosome Concentrate a (Washed)

### 2.1.1. Obtaining a HO Sunflower Oleosome Extract

In order to obtain a HO sunflower oleosome extract, 130 kg dehulled seeds from high-oleic sunflower (58.6% fat, 22.1% protein) were soaked during 24 hours in deionized water in a ratio of seeds to water of 1:2 at a temperature of 4° C. The soaking water was discarded by sieving (2 mm mesh) and the soaked seeds were washed by resuspending the seeds in deionized water in a ratio of seeds to water of 1:2 at a temperature of 4° C. The washing water was discarded by sieving (2 mm mesh) and the washed seeds were ground with deionized water in a ratio of soaked seeds to water of 1.5:3 using a toothed colloid mill (MZ-80/R, Fryma) followed by a stone mill (MK180/MZ120, FrymaKoruma) at a flow rate of 42.2 kg/h soaked seeds and 83.8 L/h deionized water fed to the hopper of the first mill. A sodium bicarbonate solution and ascorbic acid solution were added continuously until a concentration of 2.2 g/L of sodium bicarbonate and 2 g/L of ascorbic acid was obtained in the slurry. A sodium hydroxide solution at a concentration of 8% was added until a pH of 6.94 and a conductivity of 2664 microSiemens/cm was reached. A slurry of ground sunflower seeds with a dry substance of 16.64 wt. % was obtained. The slurry was subsequently decanted using a tricanter (Z2E, Flottweg). The cake (solid heavy phase) was discarded. The oleosome extract (light liquid phase) was used for further centrifugation.

### 2.1.2. Centrifugation of the HO Sunflower Oleosome Extract

The HO sunflower oleosome extract was centrifuged using a disc stack liquid-liquid separator (Easyscale 10.S, GEA Westfalia) to yield an oleosome-rich light liquid phase and heavy liquid phase which was discarded.

### 2.1.3. Washing the HO Sunflower Oleosome Fraction

The oleosome-rich light liquid phase was diluted to 15% dry substance with deionized water, brought to pH 9.5 using an 8% sodium hydroxide solution and centrifuged for a second time using a disc stack liquid-liquid separator (Easyscale 10.S, GEA Westfalia) to yield a washed oleosome-rich light liquid phaseand a watery heavy liquid phase which was discarded. Afterwards, the washed cream was standardized by bringing back the pH to 7 and diluting it to 34.9 wt. % dry substance with deionized water. This cream was subsequently pasteurized on a sterilizing equipment (HT220 series, UHT/HTST, OMVE) at 86° C. for 30 seconds. The heat-treated cream was collected in bag-in-box bags and stored at 4-7° C. The composition is shown in Error! Reference source not found. (HO sunflower oleosome concentrate A, washed, pasteurized).

### 2.2. Procedure for Obtaining HO Sunflower Oleosome Concentrate B (Microfiltered)

In order to obtain a HO sunflower oleosome extract, 1000 kg dehulled seeds from high-oleic sunflower (58.7% fat, 21.2% protein) were soaked during 24 hours in deionized water in a ratio of seeds to water of 1:2 at a temperature of 4° C. under continuous gentle stirring to keep the seeds in suspension without breaking them. The soaking water was discarded by sieving (2 mm mesh) and the soaked seeds were washed by resuspending the seeds in deionized water in a ratio of seeds to water of 1:2 at a temperature of 4° C. The washing water was discarded by sieving (2 mm mesh) and the washed seeds were ground with deionized water in a ratio of soaked seeds to water of 1.5:3 using an inline toothed colloid mill (Colloid Type E-PUC100, Probst & Class) at a flow rate of 1000 L/h. A slurry of ground sunflower seeds with a dry substance of 20.7 wt. % was obtained. A sodium bicarbonate solution and ascorbic acid solution were added continuously until a concentration of 1.64 g/L of sodium bicarbonate and 1.43 g/L of ascorbic acid was obtained in the slurry. A sodium hydroxide solution at a concentration of 8% was added until a pH of 7.1 and a conductivity of 2500 microSiemens/cm was reached. The slurry was subsequently decanted using a GEA SCD-306 decanter. The cake (solid heavy phase) was discarded. 300 kg of the obtained oleosome extract (light liquid phase) was used for further microfiltration.

The obtained HO sunflower oleosome extract was heated to 50° C. using a plate heat exchanger and collected in the feed tank for the microfiltration unit where it was kept under continuous agitation. The heated HO sunflower oleosome extract was concentrated by means of microfiltration.

Microfiltration was carried out on a single-stage tubular multi-channel ceramic microfiltration membrane (Membralox, Pall) with a membrane area of 3.8 m² and a pore size of 0.2 μm. The average transmembrane pressures at the inlet and outlet were 0.8 and 1.1 bar respectively and the circulation flow 90 m³/h (5.5 m/s). The average flux throughout the entire microfiltration process was 45 kg/h/m² and kept constant.

The pH of the obtained oleosomes retentate fraction was lowered to pH 7.0 using an 8% HCl solution. An oleosome retentate fraction with a dry substance of 14.4 wt. % was obtained.

The oleosome retentate fraction was further processed by repeating 5 times the following procedure on the same microfiltration system: one volume of oleosome retentate fraction was diluted with one volume of deionized water and subsequently concentrated by means of microfiltration until the initial volume was reached again. Subsequently the obtained retentate fraction was concentrated on the same microfiltration system until a dry substance of 20.9 wt. % was reached. The average transmembrane pressures at the inlet and outlet were 0.8 and 1.1 bar respectively and the circulation flow 90 m³/h (5.5 m/s). The average flux throughout the entire microfiltration process was 45 kg/h/m² and kept constant.

The composition is shown in Error! Reference source not found. (HO sunflower oleosome concentrate B, microfiltered).

The protein content, lipid content and dry matter content of the obtained oleosome concentrates was analyzed. Results are shown in table 1.

TABLE 1
Analysis results of the HO sunflower concentrates

| | HO sunflower | |
|---|---|---|
| | oleosome | HO sunflower |
| | concentrate A | oleosome |
| | (washed, | concentrate B |
| | pasteurized) | (Microfiltered) |
| Dry matter content (expressed as wt. % on | 34.9 | 20.9 |
| total weight of the oleosome concentrate) | | |
| Protein content (expressed as wt. % on total | 1.5 | 2.6 |
| weight of the oleosome concentrate) | | |
| Total Lipid content (expressed as wt. % on | 33.4 | 18.4 |
| total weight of the oleosome concentrate) | | |
| Protein content (expressed as wt. % in total | 4.3 | 12.2 |
| dry weight of the oleosome concentrate) | | |
| Total Lipid content (expressed as wt. % in | 95.7 | 87.8 |
| total dry weight of the oleosome | | |
| concentrate) | | |
| Free lipids (expressed as wt. % on total | 5.9 | 4.4 |
| weight of lipids) | | |
| Lipids present as oleosomes (expressed as | 89.8 | 95.6 |
| wt. % on total weight of lipids) | | |

### 3. Step i) Providing a Dairy Product

A commercially available dairy drink is provided comprising 9 wt % dairy proteins, 9 wt % lipids, 30 wt % carbohydrates, and other ingredients such as vitamins, minerals, salt in an amount lower than 1 wt %.

### 4. Step ii) Obtaining the Plant-Based Oleosomes Enriched Protein Dairy Product

The plant-based oleosomes enriched protein dairy product is prepared by adding HO sunflower oleosome concentrate A or B to the dairy drink in an amount as indicated in the table 2. The oleosome concentrate is added to the dairy drink and gently mixed with a spatula. The mixture is subsequently homogenized in a homogenizer at a pressure of 150/50 bar.

The resulting plant-based drink is UHT treated on a sterilizing equipment at 136° C./6 seconds. The heat-treated drink is collected in sterile bottles and stored at 4-7° C.

The resulting plant-based oleosomes enriched protein dairy product is shown in table 2.

TABLE 2
Composition of the plant-based oleosomes
enriched protein dairy products

| | | |
|---|---|---|
| Plant-based | Plant-based | Plant-based |
| oleosomes | oleosomes | oleosomes |
| enriched | enriched | enriched |
| protein dairy | protein dairy | protein dairy |
| product - A1 | product - A2 | product - B1 |

| | | | | |
|---|---|---|---|---|
| HO sunflower | 5 | wt. % | 10 wt. % | |
| oleosome | | | | |
| concentrate A | | | | |
| HO sunflower | | | | 10 wt. % |
| oleosome | | | | |
| concentrate B | | | | |
| Dairy drink | 95 | wt. % | 90 wt. % | 90 wt. % |
| (9 wt % dairy | | | | |
| proteins) | | | | |

1. A method of preparing a plant-based oleosomes enriched protein dairy product comprising the steps of
i) Providing a dairy product having a total amount of dairy protein in the range of 4 to 25% w/w;
ii) Adding a plant-based oleosome concentrate for obtaining a plant-based oleosomes enriched protein dairy product,
wherein the oleosome concentrate is present in an amount of from 0.3 to 12.0 wt. % expressed as dry weight on the total weight of the plant-based oleosomes enriched protein dairy product, and
wherein the plant-based oleosome concentrate has a total weight of lipids of between 70 to 98 wt. %, preferably 80 to 97 wt. %, more preferably 85 to 90 wt. %, based on the total dry weight of the plant-based oleosome concentrate; and
wherein plant-based oleosomes enriched protein dairy product is a nutritional composition or a drink.

2. The method according to claim 1, wherein the method comprises a step iii) of adding one or more additional ingredients.

3. The method according to claim 1 wherein at least 60% of the dairy proteins are provided by whey protein.

4. The method according to claim 1, wherein dairy product is comprising Ca2+ and Mg2+ cations in an amount of from 120-800 mg/100 ml.

5. The method according to claim 1, wherein the plant-based oleosome concentrate comprises isolated oleosomes, wherein at least 80 wt. %, preferably at least 90 wt. % or at least 95 wt. % or at least 98 wt. %, of the total weight of lipids in the plant-based oleosome concentrate is present in the oleosomes.

6. The method according to claim 1, wherein the plant-based oleosome concentrate comprises isolated oleosomes loaded with one or more sources of linoleic acid (ALA), long-chain polyunsaturated fatty acids (LC-PUFA), medium-chain fatty acids (MCFA), sources of triglycerides having saturated C16 fatty acids that are positioned at the sn2 position, lipophilic dietary bioactive substances or a blend of one or more thereof.

7. A plant-based oleosomes enriched protein dairy product wherein said product is having a total amount of dairy protein in the range of 4 to 25% w/w; and wherein an oleosome concentrate is present in an amount of from 0.3 to 12.0 wt. % expressed as dry weight on the total weight of the plant-based oleosomes enriched protein dairy product; and
wherein the plant-based oleosome concentrate has a total weight of lipids of between 70 to 98 wt. %, preferably 80 to 97 wt. %, more preferably 85 to 90 wt. %, based on the total dry weight of the plant-based oleosome concentrate; and wherein the plant-based oleosomes enriched protein dairy product is a nutritional composition or a drink.

8. The plant-based oleosomes enriched protein dairy product according to claim 7 wherein at least 60% of the dairy proteins are provided by whey protein.

9. The plant-based oleosomes enriched protein dairy product according to claim 7, wherein the plant-based oleosome concentrate comprises isolated oleosomes, wherein at least 80 wt. %, preferably at least 90 wt. % or at least 95 wt. % or at least 98 wt. %, of the total weight of lipids in the plant-based oleosome concentrate is present in the oleosomes.

10. The plant-based oleosomes enriched protein dairy product according to claim 7, wherein the plant-based oleosome concentrate comprises isolated oleosomes loaded with one or more sources of linoleic acid (ALA), long-chain polyunsaturated fatty acids (LC-PUFA), medium-chain fatty acids (MCFA), sources of triglycerides having saturated C16 fatty acids that are positioned at the sn2 position, lipophilic dietary bioactive substances or a blend of one or more thereof.

11. A use of a plant-based oleosome concentrate for improving the mouthfeel of a plant-based oleosomes enriched protein dairy product comprising a dairy product having a total amount of dairy protein in the range of 4 to 25% w/w; and wherein the plant-based oleosomes enriched protein dairy product is a nutritional composition or a drink.

12. The use according to claim 11 wherein the plant-based oleosome concentrate is present in an amount of from 0.3 to 12.0 wt. % expressed as dry weight on the total weight of the plant-based oleosomes enriched protein dairy product.
